(19) United States
(12) Patent Application Publication
(10) Pub. No.: US 2007/0148439 A1
(43) Pub. Date: Jun. 28, 2007

(54) Communication state activation material, communication state activation sheet and communication state activation apparatus

(76) Inventor: Takuma Sato, Tokyo (JP)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 10/589,308

(22) PCT Filed: Nov. 15, 2004
(86) PCT No.: PCT/JP04/16932

§ 371 Date: Aug. 10, 2006

(30) Foreign Application Priority Data
Feb. 13, 2004 (JP) 2004-03691

(51) Int. Cl. B32B 5/16; C03C 27/00

(52) U.S. Cl. 428/329; 428/633

(57) ABSTRACT

The present invention is a communication state activation material characterized in that a composition containing at least zirconium oxide and thorium oxide is contained. Preferably, the composition further contains at least one component selected from among aluminum oxide, silicon dioxide, ferric oxide, rare earth oxide, phosphorus pentoxide, calcium oxide, magnesium oxide, potassium oxide, sodium oxide and powdery aluminum. The content of the composition in the material may be 3 mass % or more.

### FIELD OF THE INVENTION

The present invention relates to a communication state activation material, a communication state activation sheet and a communication state activation apparatus for activating communication state such as raising transmission speed on ADSL.

### BACKGROUND OF THE INVENTION

Recently, ADSL (Asymmetric Digital Subscriber Line) communication system which makes mass storage data such as image data transmit at high speed has been rapidly spreading as cable digital communication system.

The ADSL communication system can transmit both voice and data at the same time through the existing telephone line since it uses each different band which is 0 to 4 KHz for the voice and 4 KHz to 2.2 MHz for the data. The maximum transmission speed at the ADSL communication system is different according to the contract condition between a user and a receiving station. For example, in the case that the contract speed is 8 Mbps (bits per second), the theoretical data receiving speed (down transmission speed) is 8 Mbps at maximum.

However in fact the theoretical maximum data receiving speed can not be obtained because transmission loss arises between the user and the receiving station by means of effects of a distance between the user and the receiving station, line capacity, capability and set condition of a receiving terminal, instability of process speed at a interface part, digital noise generated from each device and the like. For example, there is a problem that normal data receiving speed (down transmission speed) is slowed down to about 4 to 5 Mbps when the contract speed is 8 Mbps.

A variety of IC chips are used for many communication devices. The method projecting strong radiation into the IC chips is introduced into process of ceramic for the IC chips to hold the stability of molecule to maintain electric conductance high. However there are problems which phenomena such as resistant voltage, electron conductance, insulation loss have occurred by projection of such strong radiation.

Furthermore, there is another problem which the communication speed is slowed down since the conductance is getting worse by means of noise and resident current in the device if a splitter or a modem on the ADSL line is powered up for long time.

Furthermore, there is another problem which the communication speed is slowed down since frequency band for ADSL communication line is shared with one for voice and a part of frequency band of voice signals and data communication are overlapped.

In order to overcome the above problems, the object of the present invention is to provide a communication state activation material, a communication state activation sheet and a communication state activation apparatus which can achieve good communication state such as high transmission speed or lowering of noise and the like.

### SUMMARY OF THE INVENTION

The present invention is a communication state activation material characterized in that a composition containing at least zirconium oxide and thorium oxide is contained.

Preferably, the composition further contains at least one component selected from among aluminum oxide, silicon dioxide, ferric oxide, rare earth oxide, phosphorus pentoxide, calcium oxide, magnesium oxide, potassium oxide, sodium oxide and powdery aluminum.

The content of the composition in the material may be 3 mass % or more.

The present invention is a communication state activation sheet wherein comprises painting the communication state activation material on an aluminum plate or a copper plate as described above.

The present invention is a communication state activation apparatus wherein the communication state activation material as described above is painted on at least one element selected from among a CPU, a power supply unit, a memory, a motherboard under the CPU, a motherboard under the memory, a motherboard under the bios, the inside of a body case under the CPU, the inside of the body case under the memory, the inside of the body case under the bios, the inside of the body case under the power supply unit, the inside of a monitor case, a keyboard and a mouse.

The present invention is a communication state activation apparatus wherein the communication state activation material as described above is painted on at least one element selected from among the inside of a splitter case, the inside of a modem case and the inside of a LAN board case.

The present invention is a communication state activation apparatus wherein the communication state activation material as described above is painted on a computer and/or noise sources of peripheral thereof.

The present invention is a communication state activation apparatus wherein the communication state activation material as described above is painted on noise sources of communication devices.

The present invention is a communication state activation apparatus comprising ceramic for IC mixed with the communication state activation material as described above.

The present invention is a communication state activation apparatus comprising cable covered with covering mixed with the communication state activation material as described above.

The present invention is a communication state activation apparatus wherein the communication state activation sheet as described above is stuck on at least one element selected from among a CPU, a power supply unit, a memory, a motherboard under the CPU, a motherboard under the memory, a motherboard under the bios, the inside of a body case under the CPU, the inside of the body case under the memory, the inside of the body case under the bios, the inside of the body case under the power supply unit, the inside of a monitor case, a keyboard and a mouse.

The present invention is a communication state activation apparatus wherein the communication state activation sheet as described above is stuck on at least one element selected from among the inside of a splitter case, the inside of a modem case and the inside of a LAN board case.

The present invention is a communication state activation apparatus wherein the communication state activation sheet as described above is stuck on a computer and/or noise sources of peripheral thereof.

The present invention is a communication state activation apparatus wherein the communication state activation sheet as described above is stuck on noise sources of communication devices.

According to the present invention, it is possible to make the transmission speed high and decrease the noise to improve the communication state and the like.

### BRIEF DESCRIPTION OF THE DRAWINGS

FIG. 1 is a view shown of relation between the down transmission speed on the ADSL and the transmission loss from the user to the receiving station.

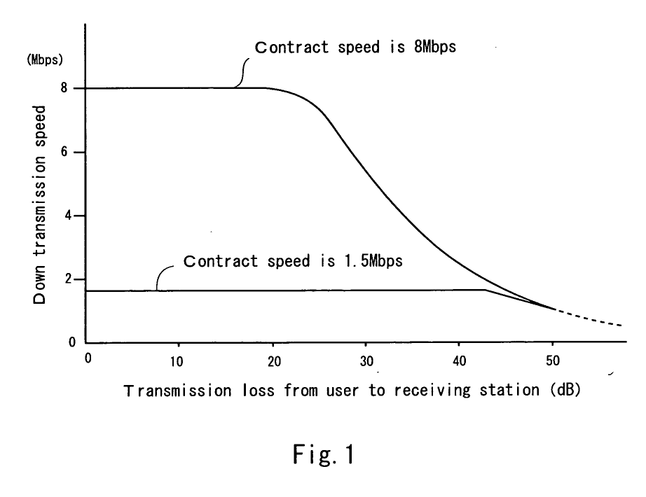

### DESCRIPTION OF THE PREFERRED EMBODIMENT

We will now describe a communication state activation material, a communication state activation sheet and a communication state activation apparatus of the present invention. We will describe a case to use in order to make the transmission speed high on the ADSL communication system as an example.

A communication state activation material of this embodiment includes a composition containing at least zirconium oxide and thorium oxide. Preferably, the composition further contains at least one component selected from among aluminum oxide, silicon dioxide, ferric oxide, rare earth oxide, phosphorus pentoxide, calcium oxide, magnesium oxide, potassium oxide, sodium oxide and powdery aluminum.

A communication state activation apparatus is constructed by painting a communication state activation material which the content of the composition in the material may be 3 mass % or preferably 4 mass % on the predetermined position of a receiving terminal and peripheral devices thereof, or sticking a communication state activation sheet painted the communication state activation material on an aluminum plate or a copper plate on the predetermined position of a receiving terminal and peripheral devices thereof. Or the communication state activation apparatus may be constructed by mixing the communication state activation material with ceramic which is material for IC chips of a CPU, a memory, a bios and the like or covering of cable and the like.

In the concrete, the communication state activation material or the communication state activation sheet is painted or stuck on at least one element selected from among a CPU in the receiving terminal, a power supply unit, a memory, a motherboard under the CPU, a motherboard under the memory, a motherboard under the bios, the inside of a body case under the CPU, the inside of the body case under the memory, the inside of the body case under the bios, the inside of the body case under the power supply unit, the inside of a monitor case, a keyboard and a mouse. Or the communication state activation material or the communication state activation sheet may be painted or stuck on at least one element selected from among the inside of a splitter case, the inside of a modem case and the inside of a LAN board case.

As the result of using the communication state activation apparatus on the ADSL communication system, the transmission speed of the receiving terminal dramatically increases. For example, typical data receiving speed (down transmission speed) exceeds 8 Mbps in the case that the contract speed is 8 Mbps.

The communication state activation material or the communication state activation sheet as the above may be painted on, mixed with or stuck on not only the receiving terminal but also a transmitting server, or may be painted on other computers and/or noise sources of peripheral devices thereof.

### The First Embodiment

At first we have done a performance test under the condition that the contract speed with the provider (OCN FLET'S ADSL) is 1.5 Mbps and the receiving terminal which is not painted and stuck the communication state activation material or the communication state activation sheet is set at the point that the distance from the receiving station is 1840 m and the transmission loss is 34 dB. As a result, the receiving terminal did not work at all.

We produced the communication state activation sheet by painting 100 g of the communication state activation material which are produced by mixing 4 g of the composition containing ingredients shown on Table.1 with water-base paint on A4 size of the aluminum plate. Afterward we cut the communication state activation sheet into 3 cm square sizes and we have done the next performance test under the condition that stuck one of them on the motherboard under the CPU. We have recognized that the receiving speed was about 1 Mbps right away and also that it was 1.5 to 1.8 Mbps after 6 days.

TABLE 1

| INGREDIENTS | CONTENT RATE(%) |
|---|---|
| Zirconium oxide | 36.52 |
| Rare earth oxide | 12.37 |
| Thorium oxide | 0.84 |
| Aluminum oxide | 6.23 |
| Ferric oxide | 0.39 |
| Calcium oxide | 0.31 |
| Magnesium oxide | 0.14 |
| Potassium oxide | 0.23 |
| Sodium oxide | 0.18 |
| Phosphorus pentoxide | 6.24 |
| Silicon dioxide | 29.77 |
| Powdery aluminum | 1.78 |
| Others | 5.00 |

TABLE 2

| ITEM | SPECIFICATION |
|---|---|
| Provider name | OCN FLET'S ADSL |
| Contract speed | 8 Mbyte |
| OS | WindowsXP Pro |
| CPU | AMD Athlon XP 1600 |
| MEM | 256 MB(PC2100 CL2.5) × 2 |
| HDD | 40 GB(IBM Ic35L040aver 07-0) |
| CD-ROM | Toshiba XM-6402(ATAPI × 32) |
| CD-RW | TEAC CD-W548E(ATAPI) |
| VIDEO | ELSA Gladiac MX(AGP 32 MB Video memory) |
| Motherboard | ECS K7S5A(SiS735 SocKetA)Bios1.5 |
| Sound | SiS900 onboard |
| LAN | SiS900 onboard |
| 300W | ATXcase |
| Modem | NTT WEST NS-3 |

Next, we have done another performance test and measured the receiving speed at the receiving terminal under the condition that the contract speed with the provider is 8 Mbps, 2 cm diameter of a round communication state activation sheet is stuck on the center of the CPU fan of the receiving terminal, 1 cm by 2 cm of a rectangle communication state activation sheet is stuck on the power supply unit, 0.5 cm by 2 cm of a rectangle communication state activation sheet is stuck on the memory of the receiving terminal, 3 cm by 3 cm of a square communication state activation sheet is stuck on each motherboard under the CPU, the memory and the bios of the receiving terminal, 5 cm by 5 cm of a square communication state activation sheet is stuck on each motherboard under the CPU, the memory, the bios and the power supply unit of the receiving terminal, 2 cm by 2 cm of a square communication state activation sheet is stuck on inside of the splitter case, 3 cm by 3 cm of two square communication state activation sheets are stuck on the facing both insides of the modem case, as shown Table.2.

The result is shown on Table.3. The segment size was 200 Kbyte at the time of the test.

TABLE 3

| SEGMENT | RECEIVING TIME(S) | SPEED(Mbps) |
|---|---|---|
| 1 | 0.015 | 106.667 |
| 2 | 0.016 | 100 |
| 3 | 0.015 | 106.667 |
| 4 | 0.016 | 100 |
| 5 | 0.016 | 100 |
| 6 | 0.015 | 106.667 |
| 7 | 0.016 | 100 |
| 8 | 0.062 | 25.806 |
| 9 | 0.016 | 100 |
| 10 | 0.016 | 100 |
| Total | 0.203 | 78.818(Average) |

Apparent from Table.3, the maximum transmission speed at the time of receiving data attains to 78.818 Mbps on average which is about ten times as high as 8 Mbps of the conventional theoretical maximum transmission speed. The reason still is not clear entirely, but we think because the process capacity and line capacity of the receiving terminal increase by sticking the communication state activation sheet on the predetermined position of the receiving terminal and peripheral communication devices thereof and the receiving terminal is always maintained in the condition that can receive all transmitting data.

### The Second Embodiment

We have measured the communication speed by using BNR and Speed Test of ADSL speed measurement website on the internet under the condition that the contract speed with the provider (BIGLOBE FLET'S ADSL) is 8 Mbps between Y's house in Fukuoka-Ken and NTT station at 2.4 km distance from the Y's house, and the communication state activation sheet is stuck on a splitter, a modem/router, a branching box, a LAN adapter in the PC, a HDD, a power supply, a CPU, a memory and the like respectively. At this test we use AMDAthlonXP1600(1.396 GHz) as the CPU, 0.5 GB as the memory, SAMSUNG-SC1296A as the HDD, SIS900(on chip) as the LAN, Windows XPProspl(virtual memory is 768 MB) as the OS.

As a result, the down transmission speed at the PC located on the Y's house was 5.3 Mbps at the BNR test and 5.5 Mbps at the Speed Test on average of ten times. And the up transmission speed was 490 Kbps at the BNR test. On one hand, the data transmission speed at the side of the NTT station was 43 bB, 7.8 Mbps.

J Generally, the transmission speed presumed based on the distance between the Y's house and the NTT station is under 3 Mbps. In fact, judging from the fact that the down transmission speed before sticking the communication state activation sheet is under 2 Mbps and many communication errors and the like were reported, the above measurement result is miraculously good. Accordingly, availability of the communication state activation sheet was validated.

### The Third Embodiment

Table.4 shows the measurement results at the time of doing the same test as the above at the internal and external seven measure points beyond the above points.

Apparent from the Table.4, it is acknowledged that the communication speed with the communication state activation sheet remarkably improves in every case.

TABLE 4

| | | CONTRACT | DISTANCE FROM | | SPEED WITHOUT | SPEED WITH |
|---|---|---|---|---|---|---|
| | MEASURE POINT | SPEED | STATION | DAMPING | SHEET | SHEET |
| 1 | Taito-ku, Tokyo | ADSL 8Mbps | 1130 m | 21 dB | 5.7Mbps | 7.8Mbps |
| | | | | | (average) | (average) |
| 2 | Nihonbashi, Chuo-ku | 12Mbps | 2000 m | 39 dB | 2.91Mbps | 3.56Mbps |
| 3 | Hiroshima-shi | 12Mbps | 1500 m | 29 dB | 5Mbps | 6Mbps |
| 4 | Construction site of | 2Mbps | 6500 m | Unknown | 450-780kbps | 1.7-1.75Mbps |
| | bullet train, Taiwan | | | | | |
| 5 | Taipei, Taiwan | 2Mbps | Unknown | Unknown | 530kbps | 1.533Mbps |
| 6 | Taipei, Taiwan | 3Mbps | 750 m | Unknown | 700k-1Mbps | 2.4Mbps-2.6Mbps |
| 7 | Hotel in Louisiana, USA | Unknown | Unknown | Unknown | 350kbps | 850kbps |

According to the communication state activation material, the communication state activation sheet and the communication state activation apparatus, it is possible to improve the communication speed since influences such as noise from outside can be eliminated, a little radiation radiated from the communication state activation material prevents residence current from generating in the devices such as the splitter or modem and the like, and thus can enhance conductance and decrease isolation loss.

Furthermore, it is possible to improve the communication speed since the communication state activation material discharges minus ion having about 4-40μ wavelength of electrons stably and thus flow of an electron in air is stabilized. It is also possible to decrease isolation loss and residence current since ambient in the devices such as the splitter or modem and the like is improved by the minus ion.

At the above embodiments, though we described the case to use the present invention in order to make the transmission speed high, it is obvious that the present invention can be applied to decrease noise of the other communication devices as well since it is acknowledged to be able to eliminate radio noise by using it at the radio or to extend a communication distance by using it at a transceiver.

Furthermore, a few doses of radiation and minus ion radiated from the communication state activation material or the communication state activation sheet of the present invention can be effectively applied to each field such as medicine, biology, physics, science, electronics, electric and the like, as a variety of studies regarding a few doses of radiation are carried out in medical and biological fields presently and Thomas D. Lucky Professor published “A few doses of radiation Horumisis Effect” to activate life action of lives by a few doses of radiation though a lot of doses of radiation are hard on the lives.

1-14. (canceled)

15. A communication state activation material comprising:
a composition having at least zirconium oxide and thorium oxide.

16. The communication state activation material of claim 15 wherein the composition further includes at least one component selected from the group consisting of aluminum oxide, silicon dioxide, ferric oxide, rare earth oxide, phosphorus pentoxide, calcium oxide, magnesium oxide, potassium oxide, sodium oxide and powdery aluminum.

17. The communication state activation material of claim 15 wherein the content of the composition in the material is at least 3 mass %.

18. A communication state activation sheet comprising:
a plate selected from the group consisting of aluminum and copper, wherein a composition having at least zirconium oxide and thorium oxide is painted on the plate.

19. The communication state activation sheet of claim 18 wherein the composition further includes at least one component selected from the group consisting of aluminum oxide, silicon dioxide, ferric oxide, rare earth oxide, phosphorus pentoxide, calcium oxide, magnesium oxide, potassium oxide, sodium oxide and powdery aluminum.

20. The communication state activation sheet of claim 18 wherein the content of the composition in the material is at least 3 mass %.

21. A communication state activation apparatus comprising:
at least one element selected from the group consisting of a CPU, a power supply unit, a memory, a motherboard under the CPU, a motherboard under the memory, a motherboard under the bios, the inside of a body case under the CPU, the inside of a body case under the memory, the inside of a body case under a bios, the inside of a body case under the power supply unit, the inside of a monitor case, a keyboard, a mouse, an inside of a splitter case, an inside of a modem case and an inside of a LAN board case, wherein a composition having at least zirconium oxide and thorium oxide is painted on the element.

22. The communication state activation apparatus of claim 21 wherein the composition further includes at least one component selected from the group consisting of aluminum oxide, silicon dioxide, ferric oxide, rare earth oxide, phosphorus pentoxide, calcium oxide, magnesium oxide, potassium oxide, sodium oxide and powdery aluminum.

23. The communication state activation apparatus of claim 21 wherein the content of the composition in the material is at least 3 mass %.

24. A communication state activation apparatus comprising:
at least one element selected from the group consisting of a computer, a noise source of a peripheral device and a noise source of a communication device, wherein a composition having at least zirconium oxide and thorium oxide is painted on the element.

25. The communication state activation apparatus of claim 24 wherein the composition further includes at least one component selected from the group consisting of aluminum oxide, silicon dioxide, ferric oxide, rare earth oxide, phosphorus pentoxide, calcium oxide, magnesium oxide, potassium oxide, sodium oxide and powdery aluminum.

26. The communication state activation apparatus of claim 24 wherein the content of the composition in the material is at least 3 mass %.

27. A communication state activation apparatus comprising:
a ceramic for integrated circuits, the ceramic mixed with a composition having at least zirconium oxide and thorium oxide is painted on the element.

28. The communication state activation apparatus of claim 27 wherein the composition further includes at least one component selected from the group consisting of aluminum oxide, silicon dioxide, ferric oxide, rare earth oxide, phosphorus pentoxide, calcium oxide, magnesium oxide, potassium oxide, sodium oxide and powdery aluminum.

29. The communication state activation apparatus of claim 27 wherein the content of the composition in the material is at least 3 mass %.

30. A communication state activation apparatus comprising:
a cable having a covering, the covering mixed with a composition having at least zirconium oxide and thorium oxide is painted on the element.

31. The communication state activation apparatus of claim 30 wherein the composition further includes at least one component selected from the group consisting of aluminum oxide, silicon dioxide, ferric oxide, rare earth oxide, phosphorus pentoxide, calcium oxide, magnesium oxide, potassium oxide, sodium oxide and powdery aluminum.

32. The communication state activation apparatus of claim 30 wherein the content of the composition in the material is at least 3 mass %.

33. A communication state activation apparatus comprising:
at least one element selected from the group consisting of a CPU, a power supply unit, a memory, a motherboard under the CPU, a motherboard under the memory, a motherboard under the bios, the inside of a body case under the CPU, the inside of a body case under the memory, the inside of a body case under the bios, the inside of a body case under the power supply unit, the inside of a monitor case, a keyboard, a mouse, an inside of a splitter case, an inside of a modem case and an inside of a LAN board case; and
a communication state activation sheet, the activation sheet including a plate selected from the group consisting of aluminum and copper, wherein a composition having at least zirconium oxide and thorium oxide is painted on the plate; wherein the activation sheet is stuck on the at least one element.

34. The communication state activation apparatus of claim 33 wherein the composition further includes at least one component selected from the group consisting of aluminum oxide, silicon dioxide, ferric oxide, rare earth oxide, phosphorus pentoxide, calcium oxide, magnesium oxide, potassium oxide, sodium oxide and powdery aluminum.

35. The communication state activation apparatus of claim 33 wherein the content of the composition in the material is at least 3 mass %.

36. A communication state activation apparatus comprising:
at least one element selected from the group consisting of a computer, a noise source of a peripheral device and a noise source of a communication device; and
a communication state activation sheet, the activation sheet including a plate selected from the group consisting of aluminum and copper, wherein a composition having at least zirconium oxide and thorium oxide is painted on the plate; wherein the activation sheet is stuck on the at least one element.

37. The communication state activation apparatus of claim 36 wherein the composition further includes at least one component selected from the group consisting of aluminum oxide, silicon dioxide, ferric oxide, rare earth oxide, phosphorus pentoxide, calcium oxide, magnesium oxide, potassium oxide, sodium oxide and powdery aluminum.

38. The communication state activation apparatus of claim 36 wherein the content of the composition in the material is at least 3 mass %.
